(19) United States
(12) Patent Application Publication
(10) Pub. No.: US 2026/0065324 A1
(43) Pub. Date: Mar. 5, 2026

(54) Method of a switch for utilities of a user profile on a software of a computer

(71) Applicant: Christopher John Fritz, Reno, NV (US)

(72) Inventor: Christopher John Fritz, Reno, NV (US)

(21) Appl. No.: 18/822,190

(22) Filed: Aug. 31, 2024

(51) Int. Cl. G06Q 30/0251; G06F 21/31; H04L 67/306

(52) U.S. Cl. CPC G06Q 30/0269; G06F 21/31; H04L 67/306

(57) ABSTRACT

The method of a switch for utilities of a user profile on a software of a computer wherein an entity exchanges content with a compiled group of entity user profiles via a group switch, assigns privacy to singular content exchanges via a scale utilizing a privacy switch, individualizing advertisement content exchanges via an advertisement switch, exchanging content software to software via a reformatting switch, and or any combination thereof. Content comprises communications, data, media, and or any combination thereof. Moreover the aforementioned switches may be produced, modified, duplicated, merged, layered, split, locked, unlocked, deleted, saved and or any combination thereof by any entity utilizing a user profile including an administrator of the software organization. Privacy ranges from confidential to public comprising: public entity user profiles, semi-private group of entity user profiles, private group of entity user profiles, confidential group of entity user profiles, and or any combination thereof.

### CROSS-REFERENCE TO RELATED APPLICATIONS

This application claims priority to provisional patent application U.S. Ser. No. 63/535,845 (“The '845 application”) filed on Aug. 31, 2023; provisional patent application U.S. Ser. No. 63/651,615 (“The '615 application”) filed on May 24, 2024; provisional patent application U.S. Ser. No. 63/678,272 (“The '272 application”) filed on Aug. 1, 2024; provisional patent application U.S. Ser. No. 63/678,559 (“The '559 application”) filed on Aug. 2, 2024; provisional patent application U.S. Ser. No. 63/685,842 (“The '842 application”) filed on Aug. 22, 2024.

### THE NAMES OF THE PARTIES TO A JOINT RESEARCH AGREEMENT

Not applicable.

### INCORPORATION-BY-REFERENCE OF MATERIAL SUBMITTED ON A READ-ONLY OPTICAL DISC, AS A TEXT FILE OR AN XML FILE VIA THE PATENT

Not applicable.

### STATEMENT REGARDING PRIOR DISCLOSURES BY THE INVENTOR OR A JOINT INVENTOR

Not applicable.

### BACKGROUND OF THE INVENTION

Software is a series of coded commands utilizing a computer language to execute actions towards a goal for a product and or service within a computer system also known as a program. A primary entity of an organization administers software and or applications utilizing a computer and a network and or virtual community for the functionality of a secondary entity utilizing a user profile to exchange content and or connect with a tertiary entity/ies of a user/s profile/s to exchange content and or connections wherein content comprises media, data, communications, and any combination thereof.

Groups switches on software provide user profiles the functionality similar to one way valves wherein content exchange is sourced solely from the current activated switch without the functionality to layer multiple switches simultaneously. Privacy settings of user profiles provide the functionality to be switched from private or public wherein singular content is without the functionality to be assigned a privacy setting. Advertisements in software are administered by the software organization unless a user profile embeds the advertisement directly into content. Reformatting from a primary software to a secondary software requires manual input from a user profile to produce content on both the primary software and the secondary software.

### BRIEF SUMMARY OF THE INVENTION

The method of a switch for utilities of a user profile on a software of a computer wherein an entity exchanges content with a compiled group of entity user profiles via a group switch, assigns privacy to singular content exchanges via a scale utilizing a privacy switch, individualizing advertisement content exchanges via an advertisement switch, exchanging content software to software via a reformatting switch, and or any combination thereof. Content comprises communications, data, media, and or any combination thereof. Moreover the aforementioned switches may be produced, modified, duplicated, merged, layered, split, locked, unlocked, deleted, saved and or any combination thereof by any entity utilizing a user profile including an administrator of the software organization. Privacy ranges from confidential to public comprising: public entity user profiles, semi-private group of entity user profiles, private group of entity user profiles, confidential group of entity user profiles, and or any combination thereof.

### BRIEF DESCRIPTION OF THE SEVERAL VIEWS OF THE DRAWING(S)

The detailed description of some of the invention is made below with reference to the accompanying FIG. 1, FIG. 2, FIG. 3, FIG. 4, and FIG. 5.

FIG. 1 illustrates the group switch (2) of compiled user profiles (3) utilized by entities comprising the Presidents of the United States of America. FANATIC1 is an entity of a user profile (1) utilizing the group switch (2) to source exchanged (5) content (4) from the user profiles (3) of the Presidents of the United States of America.

FIG. 2 illustrates the functionality of a singular entity within the user profiles (3) compiled within the group switch (2) titled presidents of the United States of America to exchange (5) a content (4) and be available for sourcing by the entity user profile (1) titled FANATIC1.

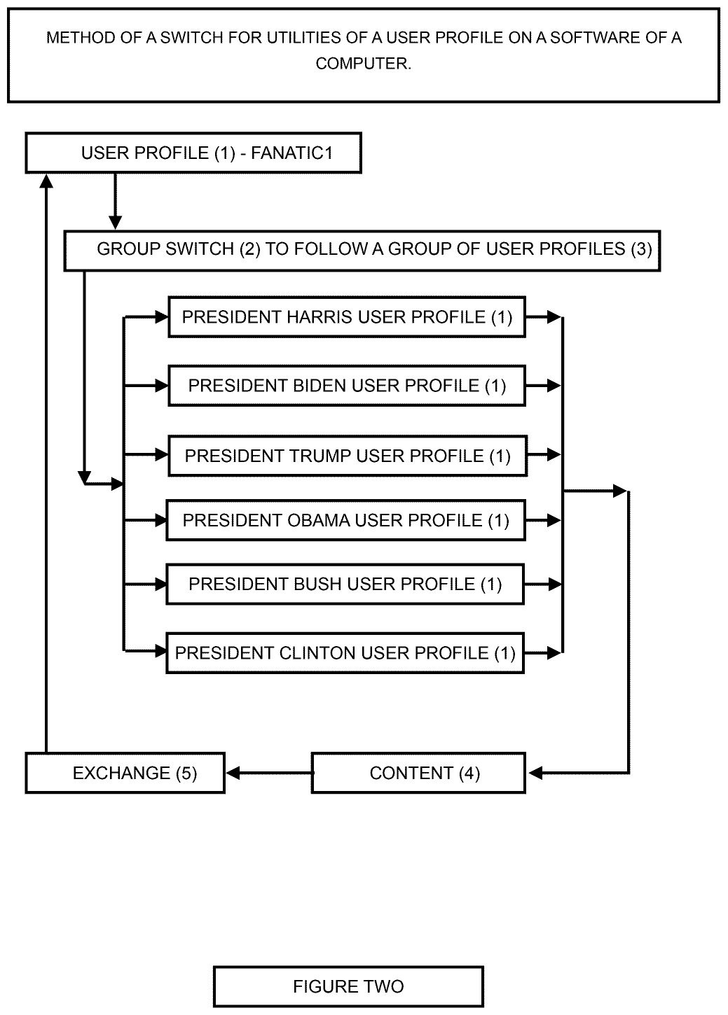

FIG. 3 illustrates an entity of the user profile (1) titled FANATIC1 utilizing numerous group switch (2) of compiled entities and their respective user profiles (3) comprising presidents, billionaires, oscar winners, fortune 500 ceos, dating profiles, and advertisements. FIG. 3 illustrates the layering of numerous group switch (2) to increase and or decrease the exchange (5) of content (4) available for sourcing by an entity and their respective user profile (1) such as FANATIC1.

FIG. 4 illustrates a privacy switch (6) for an entity of a user profile (1) titled FANATIC1 for the functionality to select from a scale of hierarchy for the desired privacy to exchange (5) content (4) with numerous entities and their respective user profiles comprising numerous compiled group switch (2) of entities from: the general public, professional entities, family entities, and or a significant other entity.

FIG. 5 illustrates the exchange (5) of content (4) by means of a reformatting switch (8) from a primary software (7) to a secondary software (9) and vise versa.

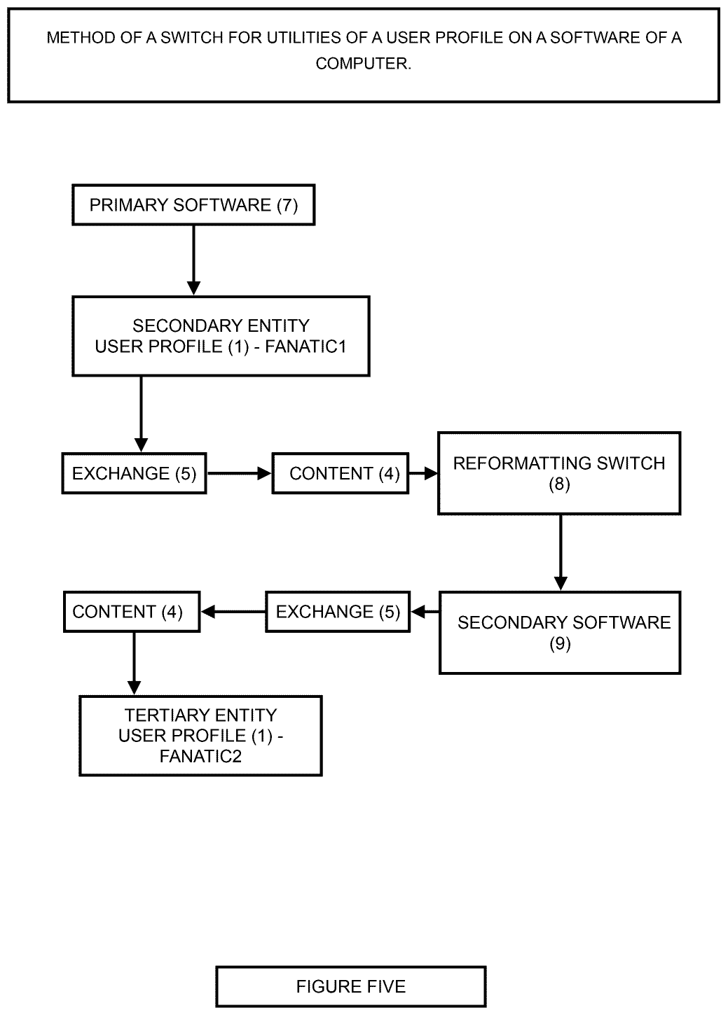

### DETAILED DESCRIPTION OF THE INVENTION

All definitions are comprising in nature. The means to functionality are method comprising due to the possibility of infinite language models and coded commands moreover artificial intelligence produced code.

Software is a series of coded commands utilizing a computer language to execute actions towards a goal for a product and or service within a computer system also known as a program.

Application is the software to effect the actions towards a goal.

Network is a series of computers in communication with each other.

Virtual communications are an exchange (5) of information within a computer network.

Administrator is a supervisor whom manages the production, utilization, and performance of an entity or program to achieve a service and or product.

User is a entity which utilizes a product and or service comprising software. An entity is a thing with existence wherein distinct comprising a biological life form, artificial intelligence, an organization including a business, and or any combination thereof. At least one of a primary entity administers the software. At least one of a secondary entity utilizes the software. At least one of a tertiary entity can exchange (5) content (4) with the primary entity and or the secondary entity. At least one of a quaternary entity comprises the primary, secondary, and or tertiary entity.

Profile is a compilation of data of an entity in a format enabled by a software.

Exchange (5) is the sharing of a product and or service comprising content (4).

Connecting is to enable the exchange (5) of content (4) over a network.

Content (4) is the products and or services to exchange (5) between users on a software comprising data, communications, media, and any combination thereof.

Media is the various means of communicating including to a mass audience comprising an exchange (5): of data, information, a medium of artistic expression, advertising, publications, periodicals, magazines, audio and or video recordings, journalism, printed press, broadcast, streaming, live performances, and or any combination thereof.

Social media are types of electronic communications wherein users produce online networks with other users to exchange (5) products, services, data, communications, content (4), and or any combination thereof.

Social media organizations are the administrators for the software of the social media.

Post is to publish a content (4) comprising products and or services on software.

Feed is the publishing of content (4) into a continuous stream.

Communications are the exchange (5) of information between entities utilizing a common language comprising sounds, gestures, signs, symbols, marks, data or any combination thereof.

Data is any measurement with an associated unit utilized for judgments.

Switches are software symbols represented graphically with the function to choose between at least two variables by means of selection. Toggle is an action to select a switch between on and off and or at least one selection of a thing vs at least one of another thing.

Produce is to create or make.

Modify is to change.

Duplicate is to copy.

Merge is to form into one unit out of at least two separate units.

Layer is a series of stratum. Layers provide the functionality means to filter content (4) exchange (5) comprising increasing and decreasing content (4) exchange (5).

Split is to divide into separate parts.

Delete is to erase. Save is to store to memory the current status for future access.

Mute is to produce silence, invisibility, and or incapable of being recognized.

Block is to deny access.

Access is the liberty to utilize a means of functionality.

Privacy is the liberty to restrict access to an entity/entities.

Public is the access by all entities.

Private is access to only authorized entities.

Confidential is a content (4) made in confidence.

Scale is a series of hierarchy comprising objective and or subjective measurements. For example a scale may be a rating from one to ten wherein ten is a paragon example rating or the scale may be a selection of avatars such as selecting two out of five stars.

A group switch (2) of compiled user profile/s of entities by categories of nouns comprise: people, places, and things wherein things is further comprising verbs and advertisements.

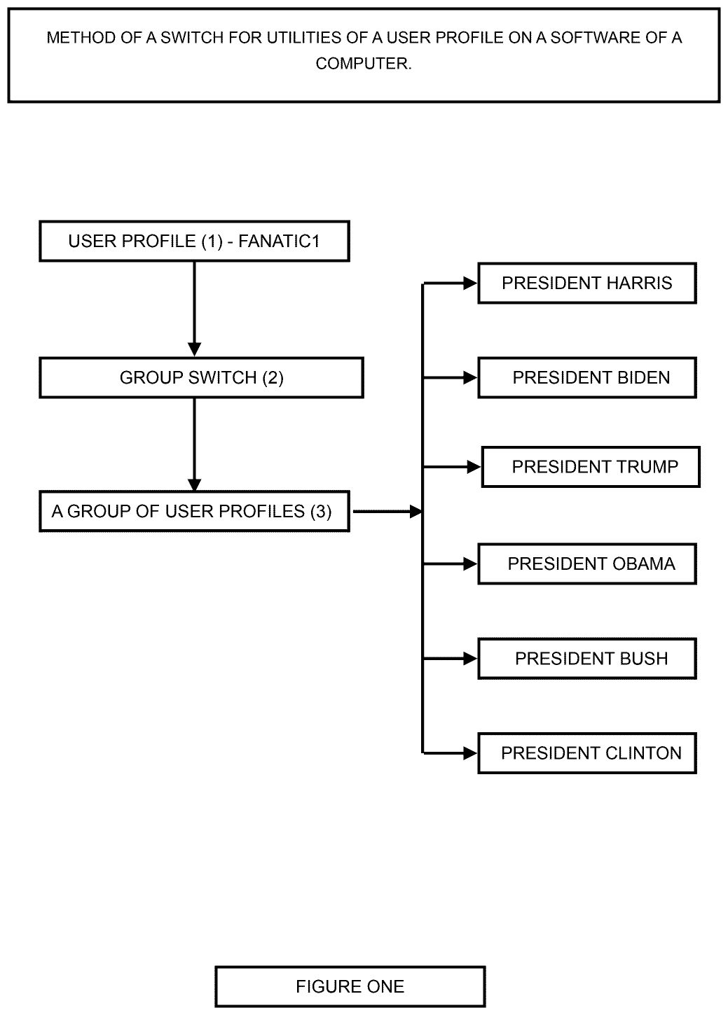

A group switch (2) of compiled user profile/s of entities by categories of people further comprise: the public, celebrities, influencers, world leaders, presidents, prime ministers, royals, statesman, Oscar winners, Emmy winners, Nobel prize laureates, pritzker prize laureates, hall of famers, athletes, athletic team rosters, hobbyists, recreationists, fortune 500 CEOs, billionaires, employees of a business, artists, olympians, teachers, professors, university presidents, religious leaders, dating profiles, volunteers, social clubs, etc. For example FIG. 1 illustrates a group switch (2) of compiled user profile/s of entities by categories of people comprising Presidents of the United States of America.

A group switch (2) of compiled user profile/s of entities by categories of places further comprise: maps, environments, zones, geographical regions, countries, states, cities, wards, zip codes, districts, neighborhoods, structures, businesses, businesses by type, amusement parks, hospitals, casinos, religious sites, restaurants, spas, salons, banks, journalism, libraries, community centers, convention centers, pavilions, amphitheaters, industrial centers, shopping centers, markets, retail, malls, fuel stations, art museums, museums, parks, performing art centers, universities, colleges, schools,

A group switch (2) of compiled user profile/s of entities by category types being things further comprising: schedules, itineraries, and or events.

Detailed examples of nouns: advertisements, advertisers, actors, actresses, actions, administrations, age groups, airports, alcohol, animals, apartments, appliances, areas, art, articles, banks, benefits, birthdays, boards, boats, books, boss, buildings, buyers, businesses, candidates, careers, cases, categories, celebrations, champions, chapters, charities, cities, classes, clients, climates, clothes, collections, colleges, committees, communities, competitions, complaints, concepts, contractors, conversations, countries, counties, crafts, criticism, cultures, currencies, customers, dates, dealers, definitions, deliveries, departments, designs, desks, devices, dinners, directors, disasters, discussions, disease, drama, economics, economy, education, employees, employers, energy, entertainment, environment, equipment, establishments, estates, events, exams, examples, exchanges, exercises, experiences, facts, families, farmers, features, feedback, fields, films, fires, fish, flights, food, force, foundations, friendship, future, games, garbage, garden, gates, genes, gifts, goals, government, groceries, groups, guests, guides, hairs, hats, health, heat, highways, history, homes, homework, hope, hospitals, hotels, houses, ideas, images, income, industry, information, inspection, insurance, internet, investment, issues, items, jobs, judgement, key, knowledge, labs, lakes, language, law, leaders, library, links, literature, locations, love, machines, magazines, maintenance, malls, management, manufacturer, maps, markets, marketing, marriage, materials, math, matter, meals, meaning, measurements, meats, media, medicine, memberships, memory, menus, message, methods, mixtures, modes, models, money, movies, music, nations, negotiation, network, news, newspaper, notes, numbers, objects, office, oil, operations, opinions, organizations, outside, owners, painting, paper, passengers, patients, performance, philosophy, phones, photos, physics, places, plans, platforms, players, poems, police, politics, pollution, positions, post, practice, presentations, problems, procedure, process, products, professions, professors, programs, property, questions, radio, rates, reality, reason, reception, recipes, recognition, recommendation, record, recordings, reflection, regions, relations, republic, reputation, resolution, resources, restaurants, results, revenue, risk, rivers, roads, rocks, roles, rooms, rules, safety, samples, scales, scenes, schools, science, screen, secretary, sections, sectors, security, selections, series, service, session, setting, shapes, share, sign, signature, singer, sir, site, situation, size, skill, society, software, soil, solution, song, sound, soup, sources space, speaker, speech, sports, square, standard, star, swarm, statement, steak, step, stock, storage, store, story, strategy, stress, structure, student, studio, study, style, subject, success, suggestion, sun, supermarket, surgery, system, table, tale, task, tax, teacher, technology, television, temperature, term, test, thanks, theory, things, thought, throat, time, tongue, tool, tooth, top, topic, town, trade, tradition, trainer, transportation, taught, two, type, union, unit, university, user, value, variation, variety, vehicle, version, video, view, village, voice, war, warning, water, way, wealth, weather, web, wedding, week, wind, winner, wood, word, work, worker, world, writer, writing, year, youth . . . etc, etc, etc.

The software has the functionality means to search for the category of a group switch (2), a privacy switch (6), an advertisement switch, a reformatting switch (8), and or any combination thereof.

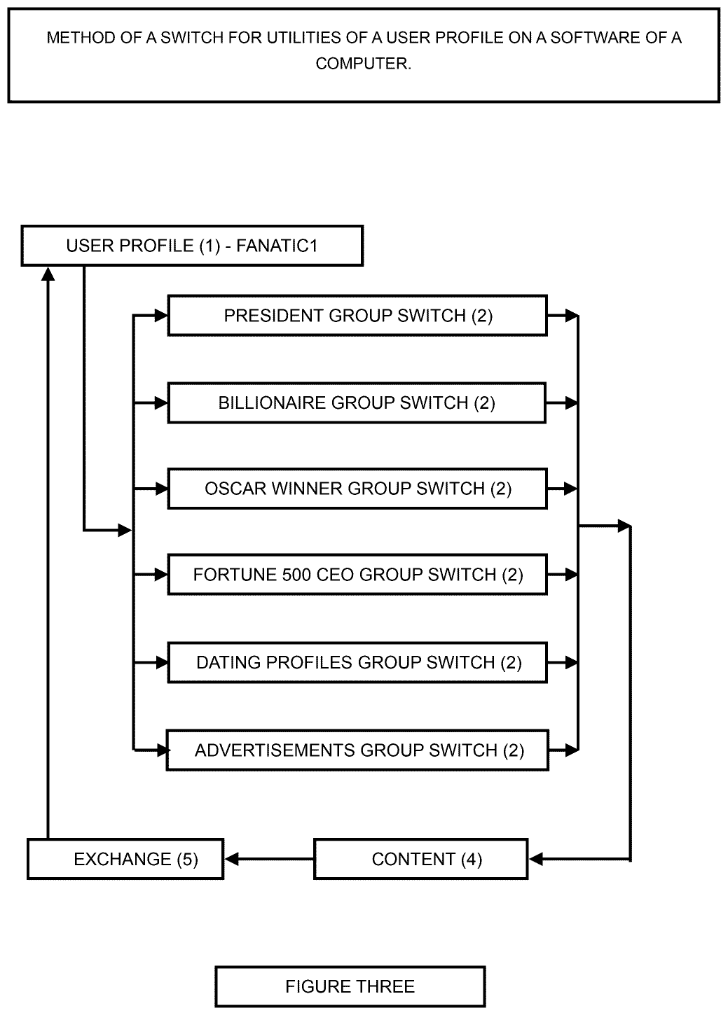

The method of a group switch (2) produces the functionality for a quaternary entity of a user profile (1) to produce and or modify a group switch (2) to exchange (5) content (4) with a complied group of quaternary entities and their respective user profiles (3). When a quaternary entity of a user profile (1) compiled within the group switch (2) produces an exchange (5) of content (4) it becomes available for sourcing by the user profile (1) of the entity utilizing the group switch (2) comprising populating into a feed. Layering numerous group switch (2) to provide the functionality means to filter the exchange (5) of content (4) comprising increasing and or decreasing the exchange (5) of content (4). Historically group switch (2) on software provides entities of user profiles the ability to log in or out wherein content (4) exchange (5) is sourced singularly from the current activated switch similar to a one way valve; this novel group switch (2) sources and or will exchange (5) content (4) from the compiling and or layering of numerous group switch (2) simultaneously as illustrated by FIG. 3.

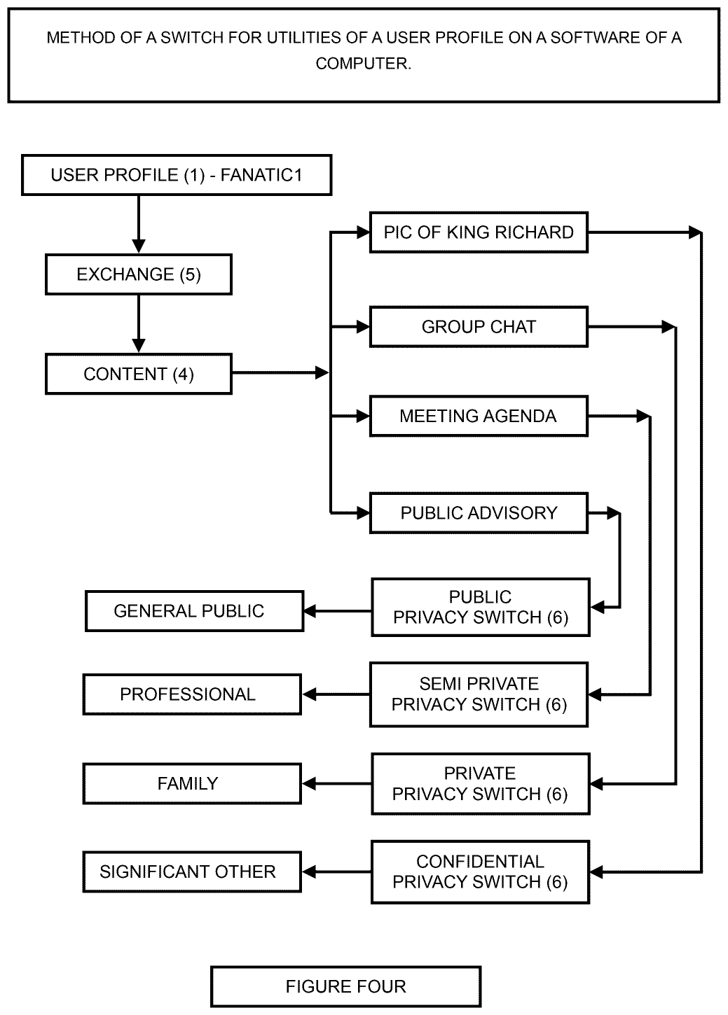

The example of a privacy switch (6) produces the functionality means to designate the exchange (5) of singular content (4) within a privacy scale ranging from private to public to determine access to the following, but not limited to, designated group switch (2) comprising: all public entity user profiles (3), a semi-private group of entity user profiles (3), a private group of entity user profiles (3), a confidential group of entity user profiles (3), and or any combination thereof. FIG. 4 illustrates the aforementioned sentence. The privacy scale may also utilize any hierarchy comprising objective and or subjective measurements. For example a privacy scale may be a rating from one to ten wherein ten is the most private example rating or the scale may be a selection of avatars such as selecting two out of five stars. Privacy settings also can be applied to a group switch (2) to provide the functionality means to compile quaternary entities and their respective user profiles (3) into a privacy hierarchy, thus when an entity of a respective user profile (1) produces exchange (5) of content (4) it can select the group switch (2) it would like to exchange (5) the content (4) with producing a targeted audience.

The example of an advertisement switch produces the functionality means for entities of their respective user profiles (3) to exchange (5) marketing content (4) within a group switch (2). An entity of a user profile (1) produces a group switch (2) wherein compiling numerous entities and their respective user profiles (3) comprising a user profile (3) whom represent advertisements and or marketers for a product and or service. An entity can select numerous groups switch (2) for advertisements of their preference to produce an individualized exchange (5) of advertisement content (4) to exchange (5) into their user profile (1). This advertisement switch produces the opportunity for singular quaternary entities whom produce a group switch (2) to negotiate with marketing organizations to produce individualized advertising and when layered with a privacy switch (6) produces a targeted audience.

The example of a reformatting switch (8) producing the functionality means to exchange (5) content (4) between a primary software (7) and a secondary software (9) via reformatting. An entity of a user profile (1) produces a content (4) on a primary software (7) and utilizes a reformatting switch (8) to exchange (5) the content (4) on a secondary software (9). The reformatting switch (8) comprises a tertiary software. This reformatting switch (8) produces the functionality for a singular entity of a user profile (1) to publish content (4) from a singular software via a reformatting switch (8) to exchange (5) content (4) within numerous alternate software formats.

As an example, a group switch (2) is produced to exchange (5) content (4) with numerous compiled entities and their respective of user profiles (3) comprising the governors of all the states in the United States of America. Since the governor's of the states are in a constant flux the group switch (2) is modified to delete proceeding user profiles (3) and add succeeding user profiles (3) to reflect the current state of the state.

The user profile (1) selecting the group switch (2) may then have the ability to modify the group switch (2) to their personal preference, including duplication, as they may not want to follow the user profile (1) for the current governor of a particular state and will have the ability to modify the user profiles (3) within the group switch (2) comprising producing, modifying, duplicating, merging, layering, splitting, locking, unlocking, deleting, saving and or any combination thereof.

As an example, a group switch (2) is produced to exchange (5) content (4) with numerous compiled entities and their respective user profiles (3) consisting of restaurant businesses and layers are added to the group switch (2) to include the type of restaurant such as a pizzeria and a layer for the region of where the restaurants are located.

An entity of a user profile (1) produces a group switch (2) other entities and their respective user profiles (3) can duplicate; for example said group switch (2) comprising numerous entities and their respective user profiles (3) being Nobel prize winners. An entity of a user profile (1) can toggle the group switch (2) for the compiled user profiles (3) of Nobel prize winner's to include or exclude the exchange (5) of content (4) by the group of Nobel prize winner user profiles (3) into the entities user profile (1) feed.

Continuing from the above example: embedded to the group switch (2) is a entities user profile (1) for advertisements wherein producing the exchange (5) of marketing content (4) individualized for a brand of a entity utilizing a user profile (3). Moreover coupling the group switch (2) to a privacy switch (6) produces a targeted audience. This produces an individualized advertising schemata allowing marketers to produce targeted sales leads and discounted offers for buyers, as well as produces the functionality for entities to negotiate with marketing organizations for compensation.

1. Method of a switch for utilities of a user profile on a software of a computer comprising:
providing a hardware of said computer to produce and or utilize said software wherein allowing the exchange of an input and or an output;
providing said software comprising:
a computer language;
a coded instruction in said computer language wherein achieving the means for a goal of said software to provide a good and or a service;
an organization to administer said software;
a primary entity of said organization administering said software;
at least one of a secondary entity utilizing said software;
at least one of a tertiary entity utilizing said software; and
a user profile to utilize said software wherein said secondary entity and said tertiary entity gaining functionality means to utilize said software for said goal of said software to provide said good and or said service;
utilizing said software by said secondary entity for the functionality means to connect with at least one of a said tertiary entity in order to exchange a content;
designating a quaternary entity as the equivalent of either said primary entity, said secondary entity, said tertiary entity, and or any combination thereof;
assigning a username to each singular said quaternary entity utilizing said software enabling a login to a singular said user profile;
producing the means for said quaternary entities to produce a password linked to said username enabling secure access to said user profile for each singular said quaternary entity wherein producing the functionality means to a login and a logout of said user profile for each singular said user profile;
producing a privacy switch for the functionality means for a singular said quaternary entity utilizing said user profile to exchange said content selectively wherein said privacy switch has the functionality means to organize a hierarchy within a scale to determine the level of privacy for the exchange of said content with said quaternary entity utilizing said user profile;
producing a group switch for the functionality means for numerous compiled said quaternary entities to exchange content simultaneously with a singular said quaternary entity;
producing an advertisement switch for the functionality means for said quaternary entity to exchange advertisement content with numerous said quaternary entity user profiles within said group switch utilizing said privacy switch;
producing a reformatting switch for the functionality means for said quaternary entity to exchange content within numerous said software simultaneously utilizing said reformatting switch;
providing the functionality means for said singular said quaternary entity to modify a switch comprising to produce, duplicate, merge, layer, split, lock, save, delete, and or any combination thereof wherein said switch comprises said grouping switch, said privacy switch, said advertisement switch, said reformatting switch, and or any combination thereof;
providing the functionality means for a singular said quaternary entity to add a singular said user profile of a singular said quaternary entity to said grouping switch, said privacy switch, said advertisement switch, said reformatting switch, and or any combination thereof;
providing the functionality means for a singular said quaternary entity to delete a singular said user profile of a singular said quaternary entity from said grouping switch, said privacy switch, said advertisement switch, said reformatting switch, and or any combination thereof;
providing the functionality means for a singular said quaternary entity to block a singular said user profile of a singular said quaternary entity within said grouping switch, said privacy switch, said advertisement switch, said reformatting switch, and or any combination thereof;
providing the functionality means for a singular said quaternary entity to mute a singular said user profile of a singular said quaternary entity within said grouping switch, said privacy switch, said advertisement switch, said reformatting switch, and or any combination thereof; and
repeating any action in any order as needed.

2. Method of a switch for utilities of a user profile on a software of a computer comprising:
compiling numerous of an entity and their respective said user profile utilizing a group switch;
exchanging a content with a singular said entity and its respective said user profile wherein sourcing said content via said group switch;
assigning a privacy scale to a singular exchange of said content via said privacy scale embedded within a privacy switch;
individualizing the exchange of said content with an advertisement via an advertisement switch;
exchanging said content from a primary software to a secondary software via a reformatting switch; and
providing the aforementioned switches the functionality to be produced, modified, duplicated, merged, layered, split, locked, unlocked, deleted, saved and or any combination thereof.
